(19) United States
(12) Patent Application Publication
(10) Pub. No.: US 2026/0159012 A1
(43) Pub. Date: Jun. 11, 2026

(54) SYSTEM FOR IMPROVING ACOUSTIC PERFORMANCE OF A PANEL USING A METAMATERIAL

(71) Applicant: Toyota Motor Engineering & Manufacturing North America, Inc., Plano, TX (US)

(72) Inventors: Xiaopeng Li, Ann Arbor, MI (US); Jaime N. Moore, Canton, MI (US); Scott P. Robison, Dexter, MI (US); Steven R. Sorenson, Ypsilanti, MI (US); Michael Paul Rowe, Pinckney, MI (US); Erin Rutledge, Tipton, MI (US); Brian J. Pinkelman, Ann Arbor, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 19/037,513

(22) Filed: Jan. 27, 2025

Related U.S. Application Data
(60) Provisional application No. 63/730,034, filed on Dec. 10, 2024.

(51) Int. Cl. B60R 13/08; G10K 11/162

(52) U.S. Cl. CPC B60R 13/0815; G10K 11/162

(57) ABSTRACT

Disclosed are systems that utilize metamaterials to improve the acoustic performance of a panel, such as a glass panel used in automotive applications. In one example, the system may include a panel having an exterior edge and a metamaterial attached adjacent to the exterior edge of the panel. The metamaterial is configured to minimize the reflection coefficient of flexural waves acting upon the panel.

### CROSS-REFERENCE TO RELATED APPLICATION

This application claims priority to U.S. Provisional Patent Application 63/730,034 entitled “Metamaterial Application to Automotive Glass for Vibration Reduction and Reduced Noise Transmission,” filed Dec. 10, 2024, the contents of which is hereby incorporated by reference in its entirety.

### TECHNICAL FIELD

The present disclosure relates to a system for improving the acoustical performance of the panel using a metamaterial.

### BACKGROUND

Structural-born noise and vibrations acting upon a structure are generally viewed as problematic. In particular, panels used in automobiles, such as automotive glass panels, can experience various types of noises that affect the overall comfort and quietness of a vehicle. Some ways of improving the acoustic performance of automotive glass panels involve increasing the mass of the automotive glass panel, using laminated acoustic glass, which incorporates a special interlayer that acts as a sound-dampening barrier, and/or modifying the design of one or more seals adjacent to the perimeter of the automotive glass panel to improve acoustic performance.

### SUMMARY

This section generally summarizes the disclosure and is not a comprehensive explanation of its full scope or all its features.

In one embodiment, a system includes a panel having an exterior edge and a metamaterial attached adjacent to the exterior edge of the panel. The metamaterial is configured to minimize the reflection coefficient of flexural waves acting upon the panel.

In another embodiment, a metamaterial is configured to be attached to an exterior edge of a panel. Like before, the metamaterial is configured to minimize the reflection coefficient of flexural waves acting upon the panel.

Further areas of applicability and various methods of enhancing the disclosed technology will become apparent from the description provided. The description and specific examples in this summary are intended for illustration only. They are not intended to limit the scope of the present disclosure.

### BRIEF DESCRIPTION OF THE DRAWINGS

The accompanying drawings, which are incorporated in and constitute a part of the specification, illustrate various systems, methods, and other forms or variations of the disclosure. It will be appreciated that the illustrated element boundaries (e.g., boxes, groups of boxes, or other shapes) in the figures represent one form or variation of the boundaries. In some forms or variations, one element may be designed as multiple elements, or multiple elements may be designed as one element. In some forms and variations, an element shown as an internal component of another element may be implemented as an external component and vice versa. Furthermore, elements may not be drawn to scale.

FIG. 1 illustrates a vehicle incorporating a system for improving the acoustical performance of a glass panel using a metamaterial.

FIG. 2 illustrates a more detailed view of the glass panel of FIG. 1 utilizing the metamaterial to improve the acoustical performance.

FIGS. 3A-3J illustrate different examples of attaching the metamaterial to a glass panel.

### DETAILED DESCRIPTION

Disclosed herein are systems for improving the acoustic performance of panels. In particular, the panels may be utilized in automotive applications, such as glass panels that may form one or more windows of an automobile. In one example, a metamaterial may be attached adjacent to an exterior edge of the panel using any one of a number of different suitable methodologies. The metamaterial is configured to minimize the reflection coefficient of flexural waves acting upon the panel. For noise reduction purposes, the metamaterial may be a material or structure that provides noise reduction benefits beyond its basic material properties of mass, thickness, stiffness, and/or damping. In one example, the metamaterial may be developed utilizing a topology optimization methodology to yield a panel flexural wave absorber, which is effective at a wide range of incidence angles. In practice, the metamaterial absorbs incident vibrational waves and significantly attenuates any reflections of the incident wave, improving the acoustic performance of the panel to which it is attached.

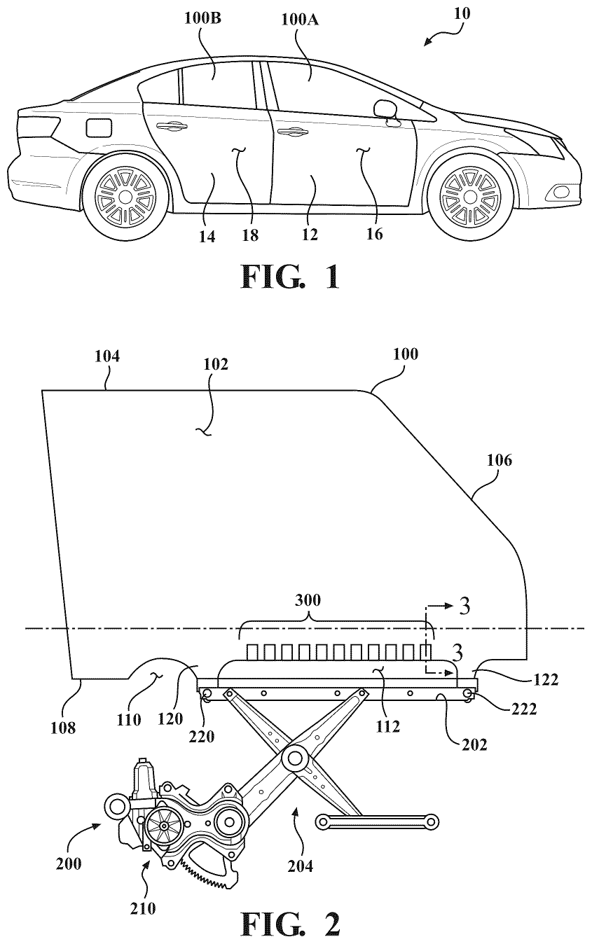

Referring to FIG. 1, illustrated is a vehicle 10, which may utilize one or more panels. In this example, the panels 100A and/or 100B are shown to be automotive glass panels that may be used as windows for the vehicle 10. It should be understood that the systems and metamaterials described herein can be used in a number of different applications and not necessarily vehicle-related applications. Furthermore, it should be understood that the type of panels that may utilize the systems and metamaterials described herein can also vary from application to application. For example, the panels may be opaque, transparent, partially transparent, and the like. The panels may be made out of different materials and be shaped differently, depending on the application and its intended use.

As mentioned before the panels 100A and 100B may be automotive glass panels that act as windows that may be able to retract, at least partially, into internal cavities 16 and 18 of doors 12 and 14, respectively. Moreover, the vehicle 10 may have the ability to open and close the windows of the vehicle 10 by extending/retracting the panels 100A and/or 100B from the internal cavities 16 and/or 18, respectively.

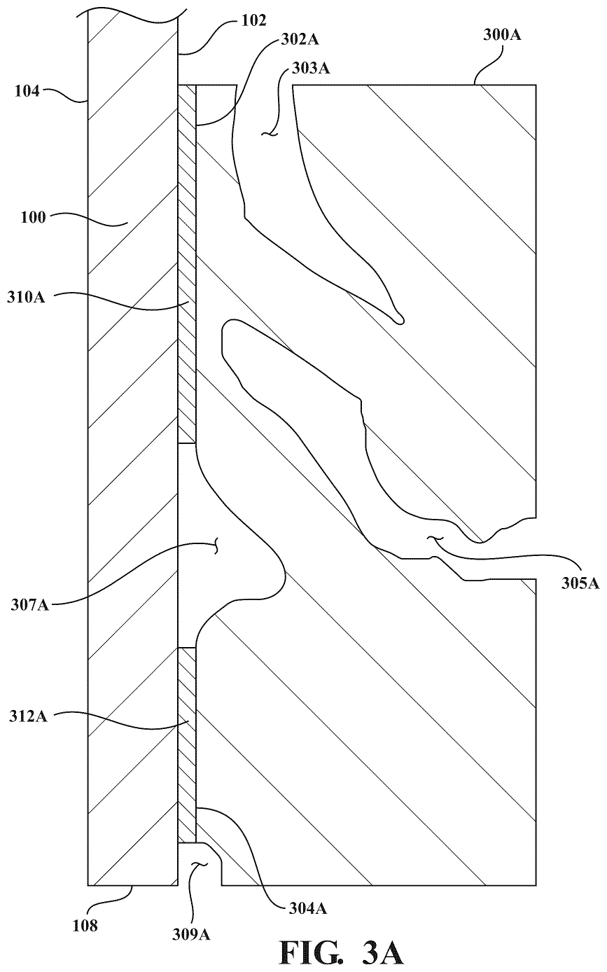

FIG. 2 illustrates a more detailed view of a panel 100. In this example, the panel 100 is equivalent to the panel 100A of FIG. 1. However, it should be understood that the description of the panel 100 would be equally applicable to the panel 100B as well. Generally, the panels 100A and 100B are substantially similar to each other and merely differ in their location and shape. As explained, the panel 100 may be a panel utilized in automotive applications, such as an automotive glass panel. However, it should be understood that this is one example of the panel 100. As mentioned before, the panel 100 can be sized and shaped and made of materials with varying properties to be utilized in a number of different applications, not just automotive-related applications and/or window applications.

Regardless of the application, the panel 100 may have a first side 102 and a second side 104. In this example, the first side 102 may be an interior side that generally faces the interior of the vehicle 10, while the second side 104 may be an exterior side that generally faces outward from the vehicle 10. The panel 100 also includes an exterior perimeter 106 that generally outlines the overall shape of the panel 100. The exterior perimeter 106 may include a perimeter portion 108 that is generally enclosed located within the internal cavity 16, regardless of whether the panel 100 is in a raised position (i.e., the panel 100 is a closed window) or a lowered or partially lowered position (i.e., the panel 100 is an open window).

The perimeter portion 108 of the exterior perimeter 106 of the panel 100 can vary from application to application but may be such that the perimeter portion 108 defines recessed portions, such as recessed portions 110 and 112 and connection points 120 and/or 122, that may be located adjacent to one or more of the recessed portions 110 and/or 112. The size and/or shape of the recessed portions 110 and/or 112 can vary from application to application. In general, the purpose of the recessed portions 110 and/or 112 is to remove unnecessary material from the panel 100 so as to reduce the mass of the panel 100 and/or shape the panel 100 to fit its desired application. In some cases, the recessed portions 110 and/or 112 are obscured from view by being located within the cavity 16 of the door 12.

As mentioned before, the panel 100 may be an automotive glass panel. More simply, the panel 100 may be in the form of a retractable window that can open and close when an occupant of the vehicle 10 presses the appropriate button. To allow for this functionality, located within the internal cavity 16 of the door 12 may be a window lift assembly 200 used to move the panel 100 between raised and lowered positions. The window lift assembly 200 may include a window lift assembly 200. The window lift assembly 200 may be mounted to an inner panel of the door 12 that at least partially defines the internal cavity 16.

A motor-driven actuator 210 is connected to a lift arm assembly 204 and is configured to move the lift arm assembly 204 between raised and lowered positions. The motor-driven actuator 210 may be connected to the lift arm assembly 204 via a gear and pinion arrangement capable of moving the lift arm assembly 204 in response to a rotary output of the motor-driven actuator 210 that may be initiated when an occupant of the vehicle 10 presses the appropriate button. The lift arm assembly 204 is connected to the panel 100 by a window regulator 202 that is connected to the panel 100 at the connection points 220 and 222. As such, when the occupant presses the appropriate button, the rotational force produced by the motor-driven actuator 210 causes the window regulator 202 to raise or lower the panel 100.

In this example, metamaterial 300 is disposed adjacent to the perimeter portion 108, which is located between the connection points 220 and 222. The metamaterial 300, as mentioned before, is configured to minimize the reflection coefficient of flexural waves acting upon the panel 100. For noise reduction purposes, the metamaterial 300 may be a material or structure that provides noise reduction benefits beyond its basic material properties of mass, thickness, stiffness, and/or damping. Moreover, the metamaterial 300 may be developed utilizing a topology optimization methodology to yield a panel flexural wave absorber, which is effective at a wide range of incidence angles. Essentially, the metamaterial 300 acts as an absorber that can exhibit total absorption of broadband flexural waves propagating along the panel 100. As used herein, the term “broadband” mass refers to a range of flexural wave frequencies greater than about 700 hertz (Hz) but could be any frequency, such as 200 Hz to 10 kHz, or any other range. For example, in some variations, the metamaterial 300 may be able to achieve near-unit absorption of flexural waves within the audible range of frequencies (i.e., the audible frequency range). As such, the metamaterial 300 greatly improves the acoustic performance of the panel 100, especially in the audible range of frequencies or any interested frequency range.

The metamaterial 300 can take any one of a number of different forms, may be in a variety of shapes, and may be made of a variety of different materials. As mentioned before, topological optimization may be utilized to generate the metamaterial 300. Topological optimization refers to a method for optimizing material distribution within a given design domain (space) as a function of one or more predefined boundary conditions such that a property or function of a component manufactured or fabricated with the optimized material distribution is enhanced and/or maximized. Additionally, the metamaterial 300 may be made up of multiple structures. For example, FIG. 2 illustrates eleven separate structures making up the metamaterial 300. However, it should be understood that the metamaterial 300 may be a single structure or may be multiple structures, as shown.

If a topological optimization methodology is utilized to design the metamaterial 300, the optimization objective of the topological optimization process may be described in the following equation:

$$min \{ {sum}_{l}^{N} ( {\vert {R}_{l} \vert}^{2} ) \} ,$$

where Rₗ=wᵣ/wᵢ, with wᵢ being an incident amplitude and wᵣ being a reflected displacement amplitude of the vibration, and l=1, 2, . . . N is a frequency index. The frequency index is essentially a range of frequencies that the design should be able to absorb. As such, the optimization problem utilizes several inputs, including the design domain, the incident amplitude, reflected displacement amplitude, and/or the frequency index. In addition, other inputs may also be utilized, such as material properties of the material that will form the metamaterial 300, physical characteristics of the panel 100, etc. The metamaterial 300 can be made out of any suitable material, such as acrylic, plastic, metals, ceramics, rubber, etc.

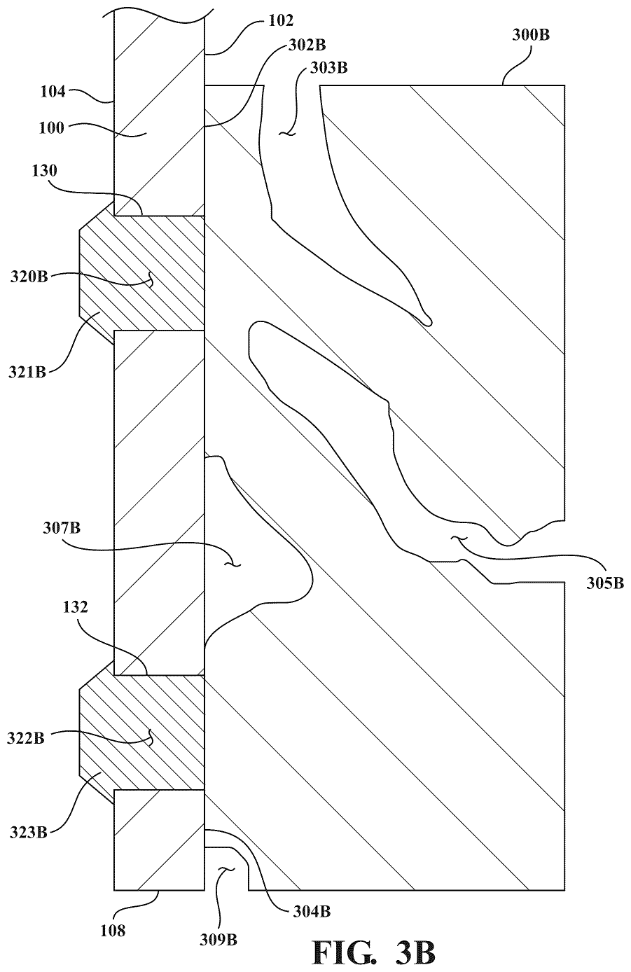

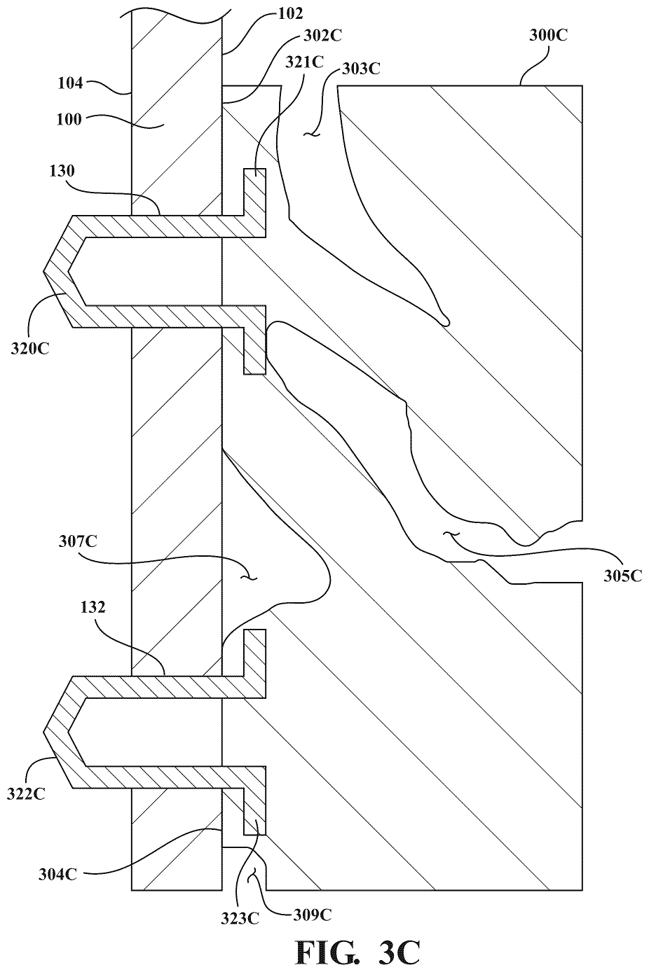

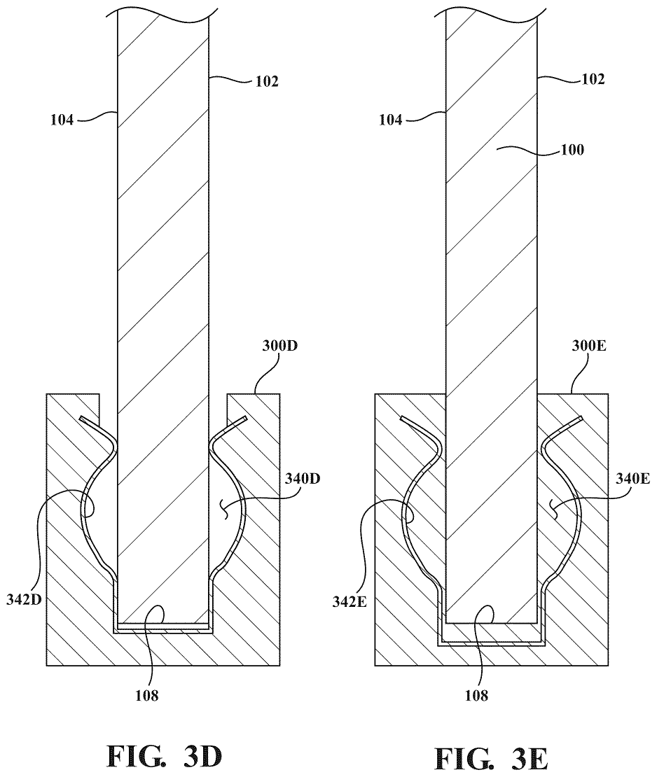

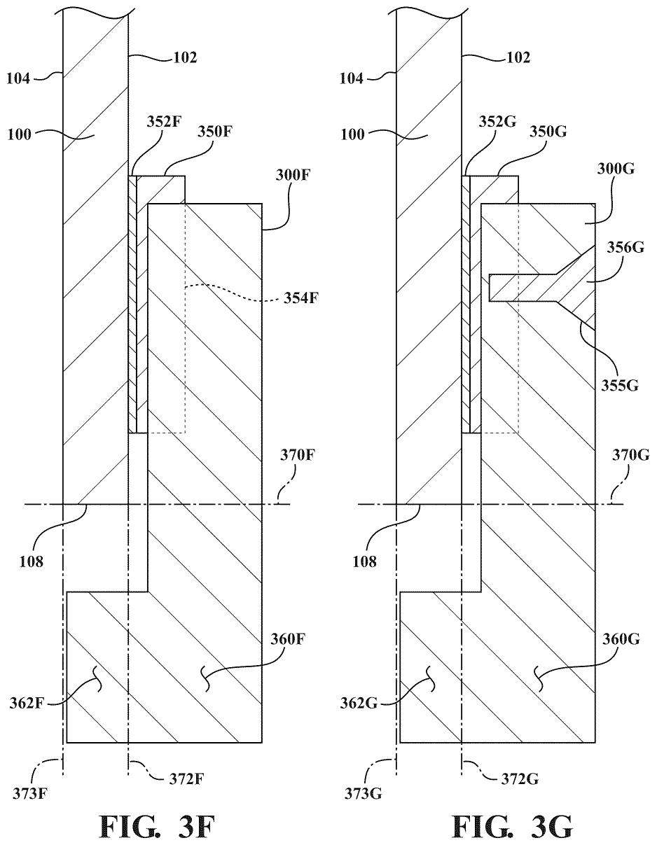

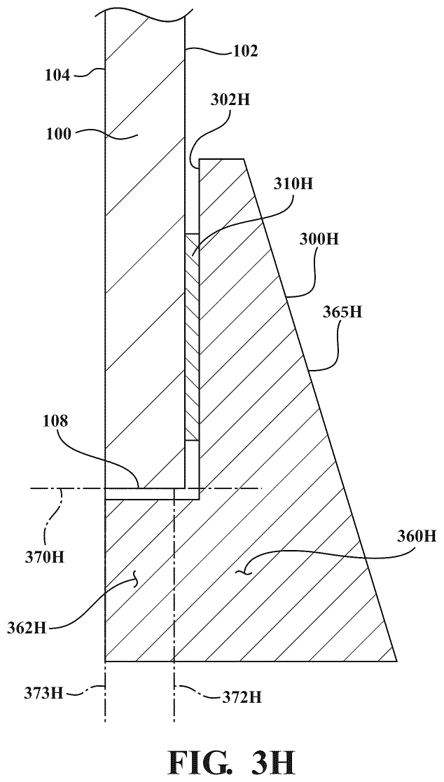

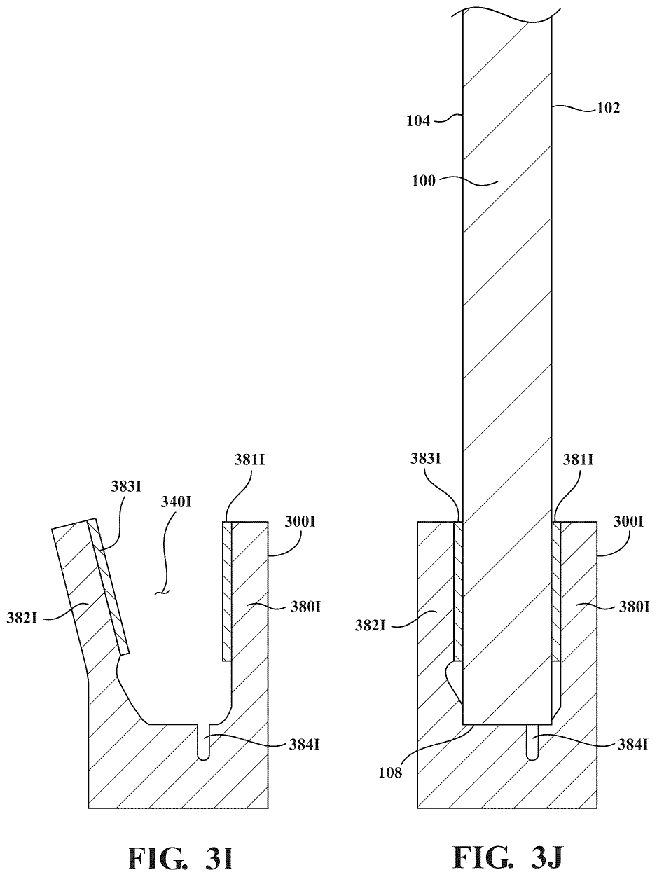

FIG. 3A illustrates one example of a metamaterial 300A generally taken along lines 3-3 of FIG. 2. Here, the metamaterial 300A may be a two-dimensional structure that includes multiple voids 303A, 305A, 307A, and 309A. As explained previously, the size and shape of the metamaterial 300A may be determined utilizing a topological optimization process, resulting in a structure with optimized material distribution within a given design domain as a function of one or more predefined boundary conditions such that a property or function of a component manufactured or fabricated with the optimized material distribution is enhanced and/or maximized. However, as explained previously, it should be understood that any process can be utilized to yield one or more different shapes of the metamaterial 300A.

Here, the metamaterial 300A includes flat portions 302A and 304A that are generally located near the first side 102 of the panel 100. In this example, the metamaterial 300A is attached to the panel 100A using adhesives 310A and 312A. The adhesives 310A and 312A function to bond the flat portions 302A and 304A, respectively, of the metamaterial 300A to the panel 100. The adhesives 310A and 312A can take any one of a number of different forms. For example, the adhesives 310A and 312A may be an epoxy resin, cyanoacrylate glue, silicone adhesives, UV-curing adhesives, acrylic adhesives, and the like. Alternatively, the adhesives 310A and 312A may be double-sided tape, which has an adhesive on both sides, allowing it to bond to the panel 100 and the flat portions 302A and 304A of the metamaterial 300A.

FIG. 3B illustrates another example of a metamaterial 300B generally taken along lines 3-3 of FIG. 2. Unless otherwise noted, like reference numerals have been utilized to refer to like elements, with the exception that the letter “B” is utilized in FIG. 3B. In this example, the panel 100 includes openings in the shape of holes 130 and 132. The metamaterial 300B may also include mold-in clips 320B and 322B that are configured to be inserted through holes 130 and 132, respectively. The mold-in clips 320B and 322B may be separate structures from that of the metamaterial 300B or may form a unitary structure along with the metamaterial 300B.

When inserted correctly, flange portions 321B and 323B of the mold-in clips 320B and 322B prevent the mold-in clips 320B and 322B from being unintentionally removed and thus retaining the metamaterial 300B to the panel 100. Generally, the flange portions 321B and 323B have a diameter greater than that of the holes 130 and 132, respectively. When inserted through the holes 130 and 132, the flange portions 321B and 323B temporarily deform, allowing the mold-in clips 320B and 322B to be inserted through the holes 130 and 132. When fully inserted, the flange portions 321B and 323B return to their original shape, preventing the metamaterial 300B from being unintentionally removed from the panel 100.

FIG. 3C illustrates another example of a metamaterial 300C generally taken along lines 3-3 of FIG. 2. Unless otherwise noted, like reference numerals have been utilized to refer to like elements, with the exception that the letter “C” is utilized in FIG. 3C. In this example, secondary clips 320C and 322C are over-molded into the metamaterial 300C. Here, the secondary clips 320C and 322C are inserted into the holes 130 and 132, respectively, and function to connect the metamaterial 300C to the panel 100.

FIG. 3D illustrates another example of a metamaterial 300D generally taken along lines 3-3 of FIG. 2. Unless otherwise noted, like reference numerals have been utilized to refer to like elements, with the exception that the letter “D” is utilized in FIG. 3D. In this example, metamaterial 300D may be a U-shaped structure having portions that are located adjacent to both the first side 102 and the second side 104 of the panel 100. Due to its structural shape, the metamaterial 300D defines a groove 340D. Here, a perimeter portion 108 of the panel 100 is inserted into the groove 340D. While a number of different methodologies can be utilized to attach portions of the metamaterial 300D that define the groove 340D to the panel 100, in this example, a U-shaped clip 342D is utilized to frictionally engage portions of the first side 102 and second side 104 of the panel 100. In the example shown in FIG. 3D, the U-shaped clip 342D is in direct contact with portions of the first side 102 and the second side 104 of the panel 100. However, in an alternative embodiment shown in FIG. 3E (unless otherwise noted, like reference numerals have been utilized to refer to like elements with the exception that the letter “E” is utilized in FIG. 3E.), the U-shaped clip 342E is shown to be embedded within metamaterial 300E and functions to bias portions of the metamaterial 300E towards the first side 102 and the second side 104 of the panel 100. By having the U-shaped clip 342E embedded within the metamaterial 300E, damage to the panel can be avoided, as the metamaterial 300E can generally be made out of a softer material than that of the U-shaped clip 342E and/or the panel 100.

FIG. 3F illustrates another example of a metamaterial 300F generally taken along lines 3-3 of FIG. 2. Unless otherwise noted, like reference numerals have been utilized to refer to like elements, with the exception that the letter “F” is utilized in FIG. 3F. In this example, it is noted that the metamaterial 300F includes a portion 360F that generally extends past a line 370F defined by the perimeter portion 108 of the panel 100 and also includes a portion 362F that generally extends past a line 372F defined by the first side 102. In this example, the portion 362F does not extend past a line 373F defined by the second side 104. As such, in this example, the metamaterial 300F is in the form of a reverse-L shape. However, as explained several times before, it should be understood that the metamaterial 300F can take any one of a number of different shapes and sizes.

The metamaterial 300F, as explained before, can be attached to the panel 100 using any one of a number of different methodologies explained herein. In this example, a structure 350F having a side that includes a button 354F is attached to the panel 100 utilizing an adhesive 352F. The adhesive 352F can be in any of the adhesives previously explained, such as epoxy, glue, double-sided tape, etc. Here, the metamaterial 300F is shaped to mate with the button 354F, thereby retaining the metamaterial 300F to the panel 100. Instead of utilizing a button structure, FIG. 3G illustrates a variation (unless otherwise noted, like reference numerals have been utilized to refer to like elements with the exception that the letter “G” is now utilized), wherein the metamaterial 370G defines a hole 355G, such that a screw 356G can retain the metamaterial 370G to the structure 350G.

FIG. 3H illustrates another example of a metamaterial 300H generally taken along lines 3-3 of FIG. 2. Unless otherwise noted, like reference numerals have been utilized to refer to like elements, with the exception that the letter “H” is utilized in FIG. 3H. In this example, the metamaterial 300H is attached to the first side 102 of the panel 100 utilizing an adhesive 310H, which could be any of the adhesives previously described, such as epoxy, glue, double-sided tape, etc. The metamaterial 300H includes an angled side 365H opposite of the flat portion 302H that is located closest to the first side 102 of the panel 100. Additionally, the metamaterial 300H also includes a portion 360H that extends past the line 370H defined by the perimeter portion 108 of the panel 100. Furthermore, the metamaterial 300H also includes a portion 362H that extends past the line 372H defined by the first side 102. In this example, the portion 362H does not extend past the line 373H defined by the second side 104.

FIGS. 31 and 3J illustrate another example of a metamaterial 300I generally taken along lines 3-3 of FIG. 2. Unless otherwise noted, like reference numerals have been utilized to refer to like elements, with the exception that the letter “I” is utilized in FIGS. 31 and 3J. In this example, the metamaterial 300I is in the shape of a living hinge having sidewall portions 380I and 382I that generally define a groove 340I. In addition, a recess 384I located at the bottom of the groove 340I may be defined by the metamaterial 300I to allow the metamaterial 300I to exhibit characteristics of a living hinge. Moreover, the living hinge may take advantage of the flexible material that forms the metamaterial 300I and/or the recess 384I, allowing the metamaterial 300I to bend around the panel 100 when the panel 100 is inserted within the groove 340I, as best shown in FIG. 3J. Adhesives 3811 and 383I sidewall portions 380I and 382I to the first side 102 and the second side 104, respectively, of the panel 100. The adhesives 3811 and 383I can include any of the adhesives described previously, including epoxy, glue, double-sided tape, etc.

The preceding description is merely illustrative in nature and is in no way intended to limit the disclosure, its application, or uses. Work of the presently named inventors, to the extent it may be described in the background section, as well as aspects of the description that may not otherwise qualify as prior art at the time of filing, are neither expressly nor impliedly admitted as prior art against the present technology.

As used herein, the phrase at least one of A, B, and C should be construed to mean a logical (A or B or C), using a non-exclusive logical “or.” It should be understood that the various steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for the general organization of topics within the present disclosure and are not intended to limit the disclosure of the technology or any aspect thereof. The recitation of multiple variations or forms having stated features is not intended to exclude other variations or forms having additional features or other variations or forms incorporating different combinations of the stated features.

As used herein, the term “about” and/or “approximately” when related to numerical values herein refers to known commercial and/or experimental measurement variations or tolerances for the referenced quantity. In some variations, such known commercial and/or experimental measurement tolerances are +/−10% of the measured value. In contrast, other variations, such as known commercial and/or experimental measurement tolerances, are +/−5% of the measured value. In contrast, still other variations, such as known commercial and/or experimental measurement tolerances, are +/−2.5% of the measured value. In at least one variation, such known commercial and/or experimental measurement tolerances are +/−1% of the measured value.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that a form or variation can or may comprise certain elements or features does not exclude other forms or variations of the present technology that do not contain those elements or features.

The broad teachings of the present disclosure can be implemented in a variety of forms. Therefore, while this disclosure includes particular examples, the true scope of the disclosure should not be limited since other modifications will become apparent to the skilled practitioner upon a study of the specification and the following claims. Reference herein to one variation, or various variations, means that a particular feature, structure, or characteristic described in connection with a form or variation or particular system is included in at least one variation or form. The appearance of the phrase “in one example” (or examples thereof) does not necessarily refer to the same variation or form. It should also be understood that the various method steps discussed herein do not have to be carried out in the same order as depicted, and not each method step is required in each variation or form.

The foregoing description of the forms and variations has been provided for purposes of illustration and description. It is not intended to be exhaustive or to limit the disclosure. Individual elements or features of a particular form or variation are generally not limited to that particular form or variation but, where applicable, are interchangeable and can be used in a selected form or variation, even if not specifically shown or described. The same may also be varied in many ways. Such variations should not be regarded as a departure from the disclosure, and all such modifications are intended to be included within the scope of the disclosure.

What is claimed is:

1. A system comprising:
a panel having an exterior edge; and
a metamaterial attached adjacent to the exterior edge of the panel, the metamaterial configured to minimize a reflection coefficient of flexural waves acting upon the panel.

2. The system of claim 1, wherein the metamaterial is configured to minimize the reflection coefficient of the flexural waves in an audible frequency range propagating towards and impinging the metamaterial.

3. The system of claim 1, wherein the panel is an automotive glass panel.

4. The system of claim 3, wherein the exterior edge includes a recessed portion located within an internal cavity of a door of a vehicle, wherein the metamaterial is attached adjacent to the recessed portion.

5. The system of claim 3, wherein the metamaterial is disposed within an internal cavity of a door.

6. The system of claim 1, further comprising at least one of a double-sided tape or an adhesive configured to attach the metamaterial to the panel.

7. The system of claim 1, wherein the metamaterial further includes a mold-in clip configured to engage an opening within the panel.

8. The system of claim 1, further comprising a secondary clip over-molded into the metamaterial configured to engage an opening within the panel, the opening being adjacent to the exterior edge of the panel.

9. The system of claim 1, wherein the metamaterial includes a groove, wherein portions of the exterior edge of the panel are disposed of within the groove.

10. The system of claim 9, further comprising a clip in contact with the metamaterial, the clip configured to retain the metamaterial to the panel.

11. The system of claim 10, wherein the metamaterial is attached to the panel using at least one of a button or a screw.

12. The system of claim 1, wherein the metamaterial includes a first portion located adjacent to a side of the panel and a second portion extending past the exterior edge of the panel.

13. The system of claim 1, wherein the metamaterial defines a groove and includes a living hinge portion configured to bend when portions of the exterior edge of the panel are disposed of within the groove.

14. A metamaterial configured to be attached to an exterior edge of a panel, the metamaterial configured to minimize a reflection coefficient of flexural waves acting upon the panel.

15. The metamaterial of claim 14, wherein the metamaterial is configured to minimize the reflection coefficient of the flexural waves in an audible frequency range propagating towards and impinging the metamaterial.

16. The metamaterial of claim 14, wherein the panel is an automotive glass panel.

17. The metamaterial of claim 16, wherein the exterior edge includes a recessed portion, wherein the metamaterial is attached adjacent to the recessed portion.

18. The metamaterial of claim 14, further comprising a mold-in clip configured to engage an opening within the panel.

19. The metamaterial of claim 14, further comprising a clip in contact with the metamaterial, the clip configured to retain the metamaterial to the panel.

20. The metamaterial of claim 14, further comprising a groove and a living hinge portion configured to bend when portions of the exterior edge of the panel are disposed of within the groove.
